(19) United States
(12) Patent Application Publication
(10) Pub. No.: US 2008/0042430 A1
(43) Pub. Date: Feb. 21, 2008

(54) Joint Hose Slippage Prevention Apparatus

(76) Inventor: Yasuaki Ichikawa, Tokyo (JP)

Correspondence Address: FROST BROWN TODD, LLC, 2200 PNC CENTER, 201 E. FIFTH STREET, CINCINNATI, OH, 45202, US

(21) Appl. No.: 11/765,715

(22) Filed: Jun. 20, 2007

(30) Foreign Application Priority Data
Jun. 21, 2006 (JP) 2006-171558

(51) Int. Cl. F16L 3/00

(52) U.S. Cl. 285/61

(57) ABSTRACT

The present invention provides a joint hose slippage prevention apparatus for preventing slippage of a joint hose connecting a suction pipe extending from a compressor and a suction pipe extending from a throttle body. The joint hose slippage prevention apparatus comprises a tension stay that fastens the compressor side and throttle body side, with ends connected to the compressor side and the throttle body side. Consequently, when the compressor side and throttle side almost separate from each other, they are held down by the tensile strength of the tension stay, whereby the relative positional relation between the compressor side and throttle side is maintained. Accordingly, it is possible to prevent the joint hose from slipping off.

### BACKGROUND OF THE INVENTION

1. Field of the Invention

The present invention relates to a joint hose slippage prevention apparatus for preventing slippage of a joint hose connecting a suction pipe extending from a compressor and a suction pipe extending from a throttle body.

2. Description of the Related Art

The engine of an automobile is an internal combustion system that repeats processes for sucking and compressing a mixed gas of oxygen and fuel, exploding the mixed gas, exhausting, etc. and converts the output obtained through these processes into driving force. A plurality of cylinders is installed inside the engine to be an internal combustion chamber. The capacity of the cylinder is a basic factor in determining the output.

Since the capacity of the cylinder is constant, a supercharging device may be installed in the suction system in order to obtain higher output.

The supercharging device is a turbo charger, a super charger, etc., which utilize the pressure of exhaust gas from the engine. All of these supercharging devices compress air supplied to the engine. By increasing oxygen and fuel supplied to the cylinder having a constant capacity, the combustion energy is increased, which results in the increased output.

The supercharging device comprises a compressor. The compressor is a gas-compressing device. The suction pipe extending from the compressor is connected to the suction pipe extending from the throttle body. The throttle body houses a valve body that controls air volume. This throttle body is attached to an intake manifold. The intake manifold is a branch pipe branching to the respective cylinders.

The air compressed in the compressor is supplied to the throttle body through the suction pipe. The air volume is controlled in the throttle body and is distributed to the respective cylinders through the intake manifold.

In general, the suction pipe extending from the compressor and the suction pipe extending from the throttle body are not completely fixed mechanically. This is to absorb vibrations from the engine and some motion caused by a rubber mount of the engine. For this reason, the suction pipe extending from the compressor and the suction pipe extending from the throttle body are connected with a joint hose generally. (Refer to Japanese Patent laid-open No. H07-332184)

FIG. 1 shows a general joint hose. FIG. 1 is a perspective view illustrating the connection by the joint hose.

A joint hose 200 is a cylinder having an inside diameter equal to the outside diameter of the suction pipe. The material of the joint hose is silicone, urethane rubber and the like. A suction pipe 100a extending from the compressor is covered with one end of the joint hose 200, which is then fastened by a belt-shaped hose band 300a. A suction pipe 100b extending from the throttle body is covered with the other end of the joint hose 200, which is then fastened by a belt-shaped hose band 300b.

Thus, continuity between the suction pipe extending from the compressor and the suction pipe extending from the throttle body is achieved through the joint hose 200. Flexibility of the joint hose 200 allows absorption of vibrations from the compressor and engine, and the continuity can be kept as far as a change in relative positional relation between the suction pipe 100a extending from the compressor and the suction pipe 100b extending from the throttle body is within a specified range.

However, in the space between the suction pipe 100a extending from the compressor and the suction pipe 100b extending from the throttle body, air at about 1.5 atm will be filled. When the joint hose 200 is not securely fastened or grease is mixed in with the air or the pressure is increased, the joint hose 200 may slip off the suction pipe 100a extending from the compressor or the suction pipe 100b extending from the throttle body.

### SUMMARY OF THE INVENTION

Taking the above problem into account, the present invention provides a joint hose slippage prevention apparatus for preventing slippage of a joint hose connecting a suction pipe extending from a compressor and a suction pipe extending from a throttle body.

According to a first aspect of the invention, a joint hose slippage prevention apparatus for preventing slippage of a joint hose connecting a suction pipe extending from a compressor and a suction pipe extending from a throttle body comprises a tension stay that couples the compressor side and the throttle body side, one end being connected to the compressor side, and the other end being connected to the throttle body side.

Further, according to a second aspect of the invention, the joint hose slippage prevention apparatus may further comprise a clamp member on the compressor side clamping the suction pipe extending from the compressor and a clamp member on the throttle body side clamping the suction pipe extending from the throttle body, and both ends of the tension stay may be fastened to the clamp member on the compressor side and the clamp member on the throttle body side, respectively.

Furthermore, according to a third aspect of the invention, the tension stay may have rod end bearings at respective ends, and may be connected to the compressor side and the throttle body side via the rod end bearings.

Still further, according to a fourth aspect of the invention, the tension stay may include a mechanism for varying and setting a length thereof.

Still further, according to a fifth aspect of the invention, the joint hose slippage prevention apparatus may further comprise a clamp member on the compressor side clamping the suction pipe extending from the compressor and a clamp member on the throttle body side clamping the suction pipe extending from the throttle body, and both ends of the tension stay may be fastened to the clamp member on the compressor side and the clamp member on the throttle body side, respectively.

Still further, according to a sixth aspect of the invention, the joint hose slippage prevention apparatus may further comprise a clamp member on the compressor side clamping the suction pipe extending from the compressor and a clamp member on the throttle body side to be attached to a portion for attachment of the throttle body together, and both ends of the tension stay may be fastened to the clamp member on the compressor side and the clamp member on the throttle body side, respectively.

Still further, according to a seventh aspect of the invention, the clamp member on the compressor side and the clamp member on the throttle body side may each include a mechanism for varying a diameter thereof in accordance with a diameter of the suction pipe.

Still further, according to an eighth aspect of the invention, the clamp member on the compressor side may include a mechanism for varying a diameter thereof in accordance with a diameter of the suction pipe.

According to the present invention, a tension stay coupling the compressor side and the throttle body side is provided, one end of which is connected to the compressor side, and the other end of which is connected to the throttle body side.

Consequently, when the compressor side and the throttle body side almost separate from each other, they will be held down by tensile strength of the tension stay, whereby a relative positional relation between the compressor side and the throttle body side is maintained. Accordingly, it is possible to prevent the joint hose from slipping off.

Further, the tension stay may have rod end bearings at the respective ends, thereby being connected to the compressor side and the throttle body side via the rod end bearings.

Consequently, it is possible to keep the relative positional relation between the compressor side and the throttle body side within a range not allowing the joint hose to slip off. This not only prevents the joint hose from slipping off but also maintains an effect of absorbing vibrations from the engine and some movement caused by the rubber mount of the engine.

Furthermore, the joint hose slippage prevention apparatus may further comprise a compressor side clamp member and a throttle body side clamp member, and both ends of the tension stay may be fastened to the compressor side clamp member and the throttle body side clamp member, respectively. Besides, the throttle body side clamp member may be attached to a portion for attachment of the throttle body together.

Consequently, the necessity of welding or piercing work at a position for attachment of the tension stay can be eliminated, whereby it is possible to save labor for repainting to prevent rusting due to welding, and maintain air tightness of a passage of compressed air.

### BRIEF DESCRIPTION OF THE DRAWINGS

FIG. 1 is a perspective view illustrating a conventional joint hose slippage prevention apparatus.

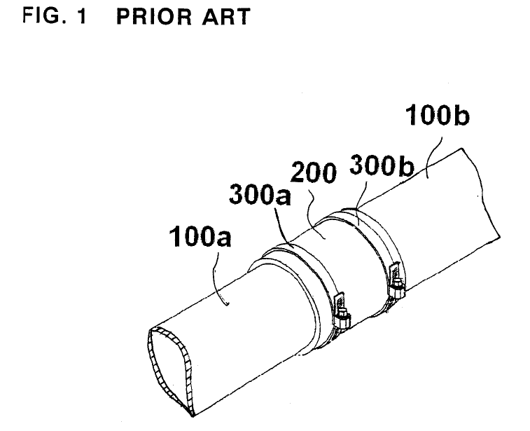

FIG. 2 is a perspective view of a joint hose slippage prevention apparatus in a first embodiment.

FIG. 3 is a perspective view of a joint hose slippage prevention apparatus in a second embodiment.

FIG. 4 is a cross-sectional view of a joint hose slippage prevention apparatus in the second embodiment.

FIG. 5 is a perspective view of a clamp member on a throttle body side of a joint hose slippage prevention apparatus in a third embodiment.

FIG. 6 is a perspective view of a joint hose slippage prevention apparatus in the third embodiment.

FIG. 7 is a perspective view of a joint hose slippage prevention apparatus in a fourth embodiment.

### DETAILED DESCRIPTION OF THE PREFERRED EMBODIMENT

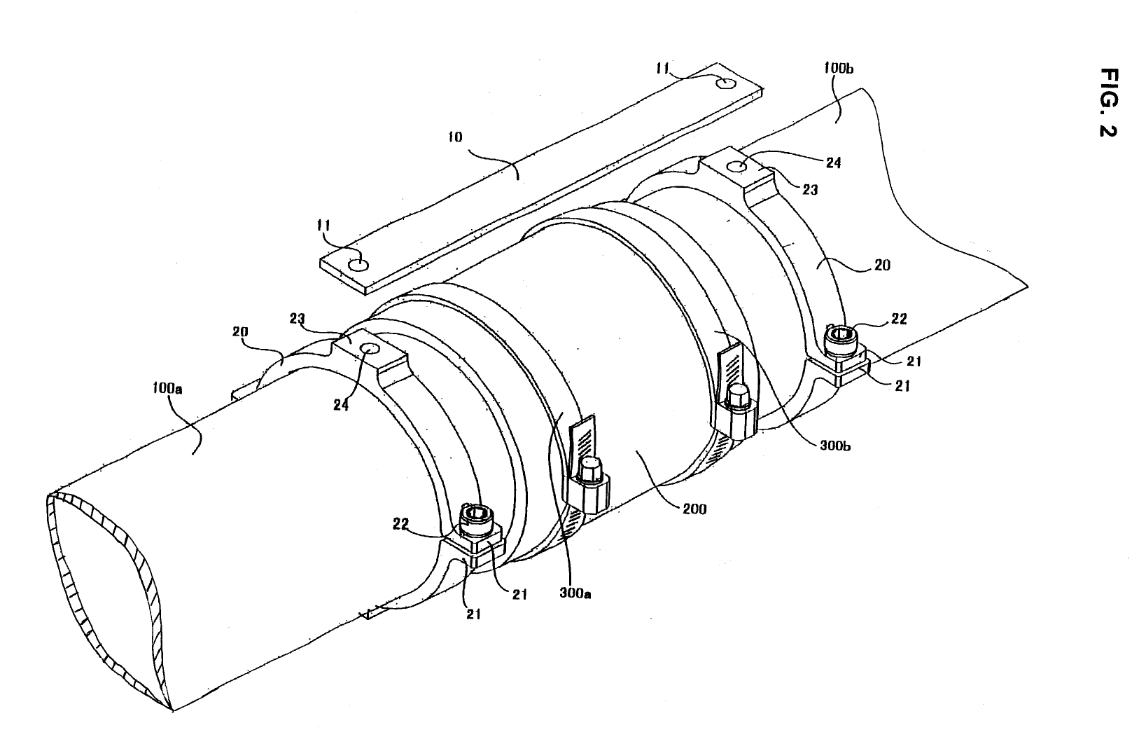

Embodiments of the present invention will be described below with reference to FIG. 2 to FIG. 7.

### First Embodiment

First, a joint hose slippage prevention apparatus of a first embodiment will be described with reference to FIG. 2. FIG. 2 is a perspective view illustrating the joint hose slippage prevention apparatus of the first embodiment.

As shown in FIG. 2, an opening of the suction pipe 100a extending from the compressor is covered with one end of the joint hose 200. An opening of the suction pipe 100b extending from the throttle body is covered with the other end of the joint hose 200.

The joint hose 200 has a shape of a cylinder composed of silicone or urethane. Through the joint hose 200, continuity is achieved between the suction pipe 100a extending from the compressor and the suction pipe 100b extending from the throttle body.

The suction pipe 100a extending from the compressor is fastened with the hose band 300a over the joint hose 200, while the suction pipe 100b extending from the throttle body is fastened with the hose band 300b over the joint hose 200.

The joint hose slippage prevention apparatus comprises a tension stay 10 and two clamp members 20.

The tension stay 10 according to the first embodiment has a belt-like, flat-plate shape. A screw hole 11 for inserting a screw is pierced at each end of the tension stay 10.

A clamp member 20 according to the first embodiment is a ring-shaped metal fitting composed of two semi-circular metal fittings. Each of the two semi-circular metal fittings composing the clamp member 20 has a flange 21 that is bent outward from the ring at the tip of the metal fitting. The clamp member 20 forms a ring-like shape by fastening the flanges 21 of the two semi-circular metal fittings with a bolt 22. On the outer circumference of the clamp member 20, a pedestal 23 protrudes outward, on which one end of the tension stay 10 is placed. A screw hole 24 for inserting a screw is drilled on the surface of the pedestal 23.

The clamp member 20 has a diameter varying mechanism that makes it possible to vary and set the diameter of the ring. Both the semi-circular metal fittings are partly hollow, and both the semi-circular metal fittings are split in the radial direction at the hollow parts. In the hollow part, a rod with the same curvature as that of the ring is provided. The inner wall of the hollow part and the rod are engaged so as to be capable of sliding on each other. By pulling the semi-circular metal fitting about the part split in the radial direction, the rod slides on the inner wall of the hollow part, whereby the rod is exposed. The circumferential length of the ring increases for the exposure length of the rod. Thus, the diameter of the clamp member 20 can be varied.

The clamp members 20 are attached to the compressor side and the throttle body side, respectively.

The diameter of one of the clamp members 20 is varied in accordance with the diameter of the suction pipe 100a on the compressor side. The suction pipe 100a is held between the semi-circular metal fittings, and the flanges 21 are aligned and fastened with the bolt 22, whereby the suction pipe 100a on the compressor side is fastened.

Similarly, the diameter of the other clamp member 20 is varied in accordance with the diameter of the suction pipe 100b on the throttle body side. The suction pipe 100b is held between the semi-circular metal fittings, and the flanges 21 are aligned and fastened with the bolt 22, whereby the suction pipe 100b on the throttle body side is fastened.

The clamp members 20 clamp the suction pipe 100a on the compressor side and the suction pipe 100b on the throttle body side, respectively, so that the pedestals 23 of the both are aligned.

One end of the tension stay 10 is placed on the pedestal 23 of the clamp member 20 clamping the suction pipe 100a on the compressor side, while the other end is placed on the pedestal 23 of the clamp member 20 clamping the suction pipe 100b on the throttle body side. Then, the screw hole 11 and the screw hole 24 of the pedestal 23 are aligned for insertion of a screw to fasten the tension stay 10 to each of the clamp members 20.

Consequently, one end of the tension stay 10 is connected to the compressor side, and the other end is connected to the throttle body side, whereby the compressor and the throttle body are coupled.

When the suction pipe 100a and the suction pipe 100b almost separate from each other due to the inner pressure generated by compressed air, they are held down by the tensile strength of the tension stay 10, whereby a relative positional relation between the compressor side and the throttle body side is kept. Accordingly, slippage of the joint hose 200 is prevented.

Furthermore, the tension stay 10 is connected to the compressor side and the throttle body side via the clamp members 20. Therefore, the need for welding and drilling on the suction pipe 100a and the suction pipe 100b can be eliminated, repainting work accompanying such welding to prevent rusting can be saved, and air tightness of the compressed air passage can be ensured.

The clamp member 20 has the diameter varying mechanism that makes it possible to vary and set the diameter. Otherwise, the clamp members 20 may be formed in accordance with the diameters of the suction pipes 100a and 100b to clamp.

### Second Embodiment

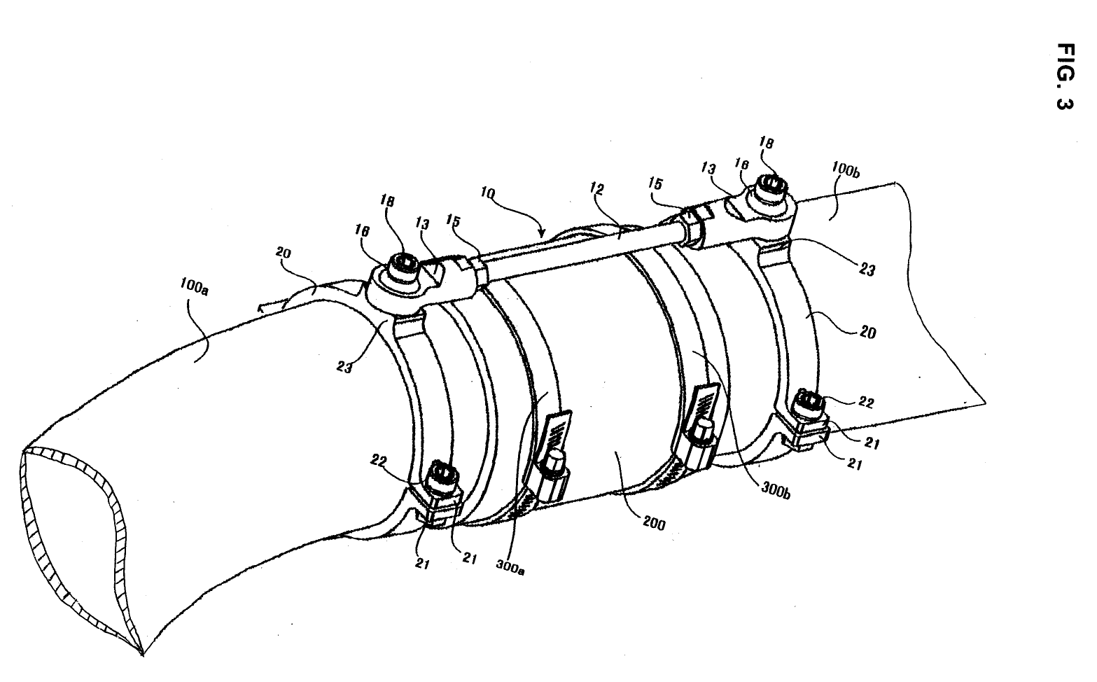

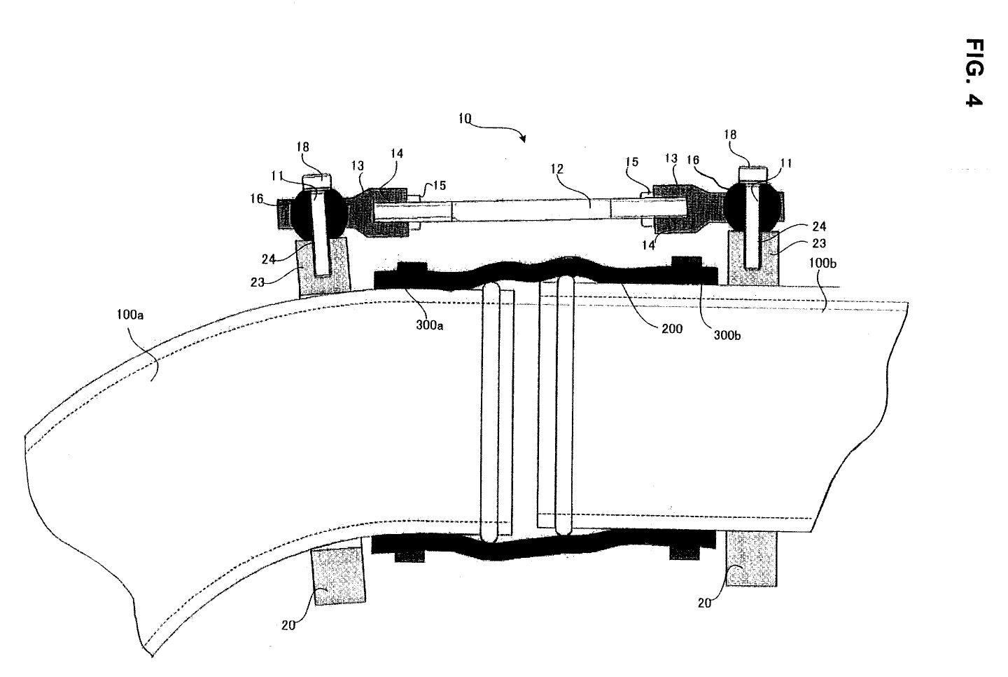

Next, a joint hose slippage prevention apparatus of a second embodiment will be described with reference to FIG. 3 and FIG. 4. FIG. 3 is a perspective view illustrating the joint hose slippage prevention apparatus in the second embodiment, and FIG. 4 is a cross-sectional view of the joint hose slippage prevention apparatus in the second embodiment.

The joint hose slippage prevention apparatus of this embodiment is especially favorable in a case where the suction pipe 100a and the suction pipe 100b are deviated in a facing position relation. Since the joint hose 200 is composed of silicone, urethane and the like, the joint hose transforms to cover both the suction pipes 100a and 100b and achieve continuity therebetween.

The tension stay 10 of the joint hose slippage prevention apparatus according to the second embodiment has rod end bearings 13 at both the ends of a rod 12, respectively.

A groove is provided on the outer circumference surface at each end of the rod 12, and a screw hole 14 having a groove on the inner wall surface is drilled on the rod end bearing 13. After nuts 15 are fit on the respective ends of the rod 12, the respective ends of the rod 12 are screwed into the screw holes 14 of the rod end bearings 13. The rod end bearing 13 and the nut 15 serve as a mechanism for varying the length of the tension stay 10. After the depth of screwing into the screw hole 14 of the rod 12 is adjusted, the depth is fixed with the nut 15.

A bearing 16 is fit on the tip of the rod end bearing 13 so as to be capable of rotating. A screw hole 11 is pierced at the center of the bearing 16.

By aligning the screw hole 11 and the screw hole 24 drilled on the pedestal 23 of the clamp member 20, and then fastening with a screw 18, one end of the tension stay 10 is connected to the compressor side, and the other end is connected to the throttle body side, whereby the tension stay 10 couples the compressor side and the throttle body side.

In a case where the suction pipe 100a and the suction pipe 100b are deviated in the facing position relation, the axial line direction of the screw hole 24 drilled on the pedestal 23 of the suction pipe 100a and the axial line direction of the screw hole 24 drilled on the pedestal 23 of the suction pipe 100b become different.

At the time of coupling with the tension stay 10, the axial lines of the screw holes 11 at both the ends of the tension stay 10 coincide with the axial lines of the screw holes 24 drilled on the pedestals 23 of the suction pipes 100a and 100b, respectively, due to free rotation of the bearings 16, whereby the screws 18 can be screwed in through the screw holes 11 and the screw holes 24, respectively.

A relative positional relation between the suction pipe 100a extending from the compressor and the suction pipe 100b extending from the throttle body changes due to vibrations from the engine and some movement by the rubber mount of the engine. Since the bearing 16 fit on the rod end bearing 13 rotates in accordance with such change, the bearing 16 does not hinder a change in the relative positional relation between the suction pipe 100a extending from the compressor and the suction pipe 100b extending from the throttle body.

Consequently, the joint hose slippage prevention apparatus according to this embodiment can maintain the relative positional relation between the suction pipe 100a extending from the compressor and the suction pipe 100b extending from the throttling body within a range not allowing the joint hose 200 to slip off, and can maintain the effects of preventing slippage of the joint hose 200 and absorbing vibrations from the engine and some movement caused by the rubber mount of the engine.

### Third Embodiment

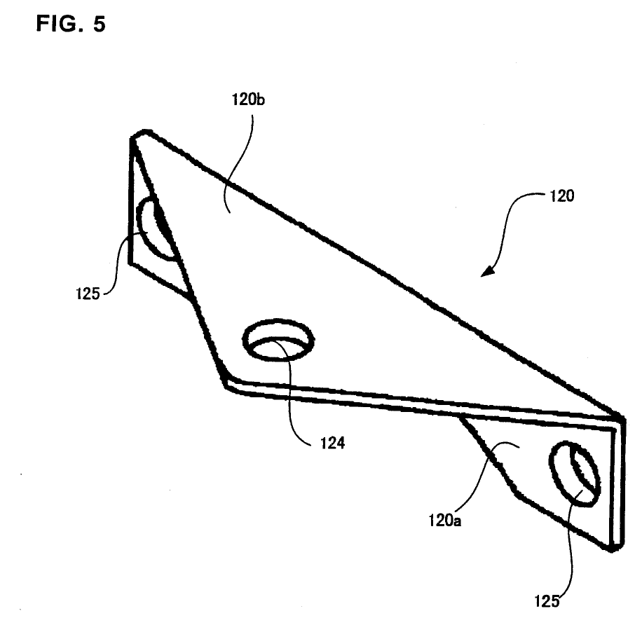

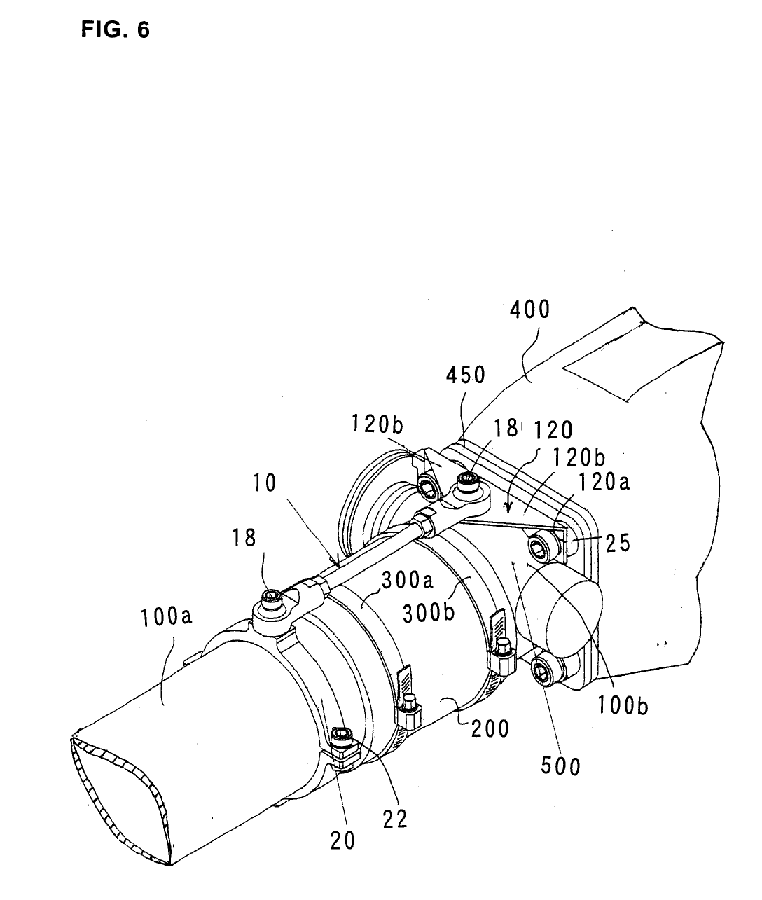

Next, a joint hose slippage prevention apparatus of a third embodiment will be described with reference to FIG. 5 and FIG. 6. FIG. 5 is a perspective view showing a clamp member 120 on the throttle body side of the joint hose slippage prevention apparatus in the third embodiment.

The clamp member 120 on the throttle body side has a shape of a flat plate bent into an L-letter shape, and two planes thereof are substantially orthogonal. One of the planes functions as an attachment plane 120a attached to a throttle body 500, and the other plane functions as a fasten plane 120b fastened to the tension stay 10.

Two screw holes 125 are pierced on the attachment plane 120a. A space between the screw holes 125 is equal to a space between screw holes drilled on a throttle body attachment plane 450 for attachment of a throttle body 500, the plane 450 being placed on an intake manifold 400.

The fasten plane 120b is provided with a screw hole 124 into which the screw 18 is inserted via the screw hole 11 of the tension stay 10.

On the intake manifold 400, the throttle body 500 is attached to the throttle body attachment plane 450. The clamp member 120 on the throttle body side is attached by aligning the throttle body 500 with the throttle body attachment plane 450, aligning the attachment plane 120a from above the throttle body, and then fastening together.

The tension stay 10 is connected to the throttle body side by aligning the screw hole 11 with the screw hole 24 of the fasten plane 120b, and then inserting and screwing the screw 18 into the screw hole 11 and the screw hole 24.

Consequently, inner pressure is generated by compressed air. When the suction pipe 100a and the suction pipe 100b almost separate from each other, the tensile strength of the tension stay 10 holds them down, whereby the relative positional relation between the compressor side and the throttle body side is maintained. Accordingly, the joint hose 200 can be prevented from slipping off.

Additionally, in a case where the tension stay 10 comprises the rod 12 and the rod end bearing 13, it is possible to prevent slippage of the joint hose 200 and maintain the effect of absorbing vibrations from the engine and some movement caused by the engine rubber mount.

### Fourth Embodiment

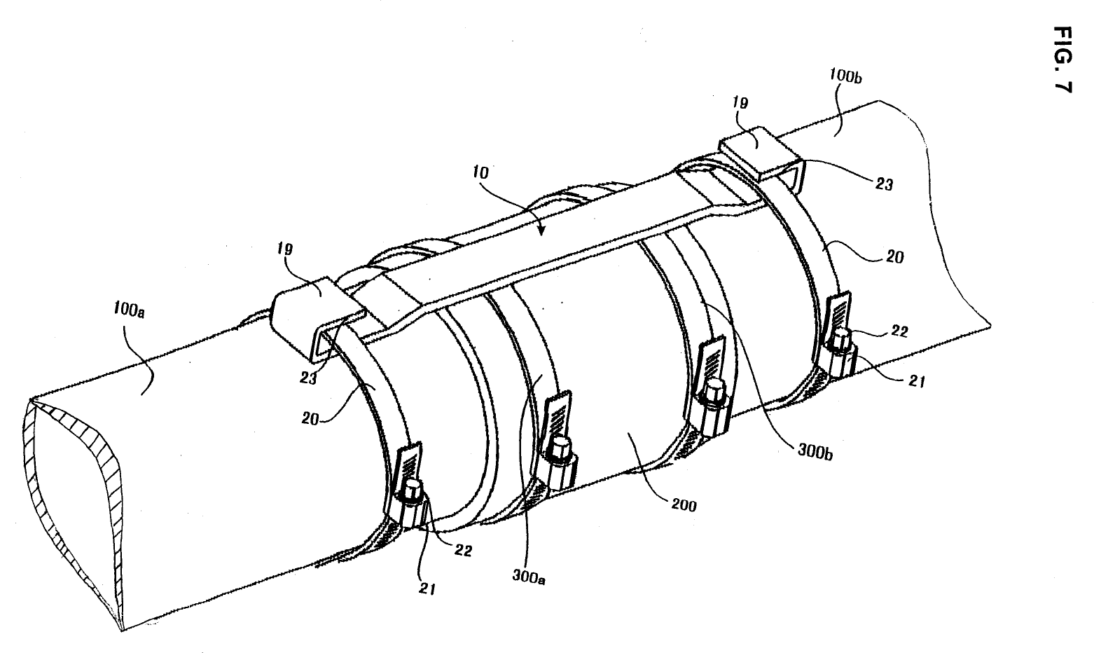

Next, a joint hose slippage prevention apparatus of a fourth embodiment will be described with reference to FIG. 7. FIG. 7 is a perspective view of the joint hose slippage prevention apparatus in the fourth embodiment.

The joint hose slippage prevention apparatus according to the fourth embodiment employs a hose band as the clamp member 20.

This clamp member 20 is a freely bendable, belt-shaped metal fitting. The clamp member 20 has the flange 21 at one end. The flange 21 has a rectangular through hole into which the other end can be inserted and a screw hole. The respective clamp members 20 are wound around the suction pipes 100a and 100b. Then, the other end of each clamp member is inserted into the through hole of the flange 21 and fixed to one end with the bolt 22.

The tension stay 10 is bent at both the ends to form hooks 19.

According to this joint hose slippage prevention apparatus, the suction pipes 100a and 100b are clamped with the clamp members 20, respectively, and the hooks 19 are suspended on the clamp members 20, whereby the tension stay 10 is connected to the compressor side and throttle body side to couple them.

Since the tension stay 10 is engaged with the clamp members 20 by suspending the hooks 19, a change in the facing position relation between the suction pipe 100a and the suction pipe 100b will not be hindered within a range specified.

What is claimed is:

1. A joint hose slippage prevention apparatus for preventing slippage of a joint hose connecting a suction pipe extending from a compressor and a suction pipe extending from a throttle body, comprising a tension stay that couples said compressor side and said throttle body side, one end being connected to said compressor side, and the other end being connected to said throttle body side.

2. A joint hose slippage prevention apparatus according to claim 1, further comprising:
a clamp member on the compressor side clamping said suction pipe extending from said compressor; and
a clamp member on the throttle body side clamping said suction pipe extending from said throttle body,
wherein both ends of said tension stay are fastened to said clamp member on the compressor side and said clamp member on the throttle body side, respectively.

3. A joint hose slippage prevention apparatus according to claim 1, wherein said tension stay has rod end bearings at respective ends, and is connected to said compressor side and said throttle body side via said rod end bearings.

4. A joint hose slippage prevention apparatus according to claim 1, wherein said tension stay includes a mechanism for varying and setting a length thereof.

5. A joint hose slippage prevention apparatus according to claim 1, further comprising:
a clamp member on the compressor side clamping said suction pipe extending from said compressor; and
a clamp member on the throttle body side clamping said suction pipe extending from said throttle body,
wherein both ends of said tension stay are fastened to said clamp member on the compressor side and said clamp member on the throttle body side, respectively.

6. A joint hose slippage prevention apparatus according to claim 1, further comprising:
a clamp member on the compressor side clamping said suction pipe extending from said compressor; and
a clamp member on the throttle body side to be attached to a portion for attachment of said throttle body together,
wherein both ends of said tension stay are fastened to said clamp member on the compressor side, and said clamp member on the throttle body side, respectively.

7. A joint hose slippage prevention apparatus according to claim 5, wherein said clamp member on the compressor side and said clamp member on the throttle body side each include a mechanism for varying a diameter thereof in accordance with a diameter of said suction pipe.

8. A joint hose slippage prevention apparatus according to claim 6, wherein said clamp member on the compressor side includes a mechanism for varying a diameter thereof in accordance with a diameter of said suction pipe.
